(19) United States
(12) Patent Application Publication
(10) Pub. No.: US 2026/0340907 A1
(43) Pub. Date: Oct. 29, 2026

(54) Imagery synthesis system and method

(71) Applicant: AURA Technologies, LLC, Chapel Hill, NC (US)

(72) Inventors: Ziye Xu, Raleigh, NC (US); Alex Blate, Chapel Hill, NC (US); Michael Costanzo, Releigh, NC (US); Anna Bennett, Chapel Hill, NC (US)

(21) Appl. No.: 19/657,815

(22) Filed: Apr. 24, 2026

Related U.S. Application Data
(60) Provisional application No. 63/794,886, filed on Apr. 25, 2025.

(51) Int. Cl. G06T 11/60; G06N 20/00

(52) U.S. Cl. CPC G06T 11/60; G06N 20/00; G06T 2200/24

(57) ABSTRACT

Systems and methods for synthesizing training imagery. The method includes receiving at an interface as an input semantic content of an object; receiving at the interface as an input at least a first style; and applying, using one or more processors executing instructions stored on memory, the first style to the semantic content. The method further includes generating, using the one or more processors, a training set including at least one training imagery item comprising a rendering of the first style applied to the semantic content of the object.

### CROSS REFERENCE TO RELATED APPLICATIONS

The present application claims the benefit of and priority to co-pending U.S. provisional Application No. 63/794,886 , filed on Apr. 25, 2025, the content of which is hereby incorporated by reference as if set forth in its entirety herein.

### TECHNICAL FIELD

Embodiments described herein generally relate to systems and methods for processing imagery.

### BACKGROUND

Drawings in disciplines such as engineering or architectural design are typically specified as scale or measured drawings. Drawings for these types of disciplines were typically made manually by a draftsman. For example, draftsman or other trained personnel would manually produce scale or measured drawings, such as by following industry- or domain-specific guidelines or standards. Standards bodies such as the American Society of Mechanical Engineers (ASME), Society of Automotive Engineers (SAE), and International Organization for Standardization (ISO) promulgated standards and guidelines for drawings, and these standards and guidelines continue to evolve to this day.

Computer-aided design (CAD) and digital tools have replaced hand drawings in most disciplines. These digitally-produced mechanical drawings still follow the same type of standards as hand drawings. Oftentimes, however, the only available mechanical designs or specifications for a part of interest may comprise images of mechanical drawings. An entity may therefore have no suitable techniques for extracting information from these images.

A need exists, therefore, for systems and methods for overcoming the above disadvantages of existing imagery applications and techniques.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

According to one aspect, embodiments relate to method for synthesizing training imagery. The method includes receiving at an interface as an input semantic content of an object; receiving at the interface as an input at least a first style; applying, using one or more processors executing instructions stored on memory, the first style to the semantic content; and generating, using the one or more processors, a training set including at least one training imagery item comprising a rendering of the first style applied to the semantic content of the object.

In some embodiments, the at least one training imagery item includes a visual representation or a rendering of the object.

In some embodiments, the semantic content includes structured data, numeric data, metadata, parameterization, metadata, or a representation or encoding of a geometric or visual element.

In some embodiments, the method further includes generating, using the one or more processors, at least a first ground-truth data item comprising the first style applied to the semantic content. In some embodiments, the method further includes receiving at a model training system at least the training imagery item and at least the first ground-truth data item; evaluating, using the one or more processors, a model of the model training system by providing the model with the training imagery item; comparing, using one or more processors, the model's output and at least the first ground-truth data item; and updating the model based on the comparison.

In some embodiments, at least one of the application of the first style to the semantic content or a rendering of the first style applied to the semantic content is deterministic.

In some embodiments, the training imagery item is a synthetic imagery item of the object.

In some embodiments, the generated training set includes a plurality of training imagery items, wherein each of the plurality of training imagery items includes the semantic content with a different style applied.

In some embodiments, applying the first style to the semantic content includes applying at least one of a parametric transform or a noise parameter to the semantic content.

In some embodiment, the semantic content includes machine-readable instructions.

According to another aspect, embodiments relate to a system for synthesizing training imagery. The system includes an interface for receiving semantic content of an object and at least a first style; and one or more processors executing instructions stored on memory and configured to apply the first style to the semantic content, and generate a training set including at least one training imagery item comprising a rendering of the first style applied to the semantic content of the object.

In some embodiments, at least one training imagery item includes a visual representation or a rendering of the object.

In some embodiments, the semantic content includes structured data, numeric data, metadata, parameterization, metadata, or a representation or encoding of a geometric or visual element.

In some embodiments, the one or more processors are further configured to generate at least a first ground-truth data item comprising the first style applied to the semantic content.

In some embodiments, the one or more processors are further configured to execute a model training system configured to receive at least the training imagery item and at least the first ground-truth data item, evaluate a model of the model training system by providing the model with the training imagery item, compare the model's output and at least the first ground-truth data item, and update the model based on the comparison.

In some embodiments, at least one of the application of the first style to the semantic content or a rendering of the first style applied to the semantic content is deterministic.

In some embodiments, the training imagery item is a synthetic imagery item of the object.

In some embodiments, the generated training set includes a plurality of training imagery items, wherein each of the plurality of training imagery items includes the semantic content with a different style applied.

In some embodiments, the one or more processors apply the first style to the semantic content by applying at least one of a parametric transform or a noise parameter to the semantic content.

In some embodiments, the semantic content includes machine-readable instructions.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 illustrates an image partitioning system in accordance with one embodiment;

FIG. 2 depicts a flowchart of a method for processing imagery in accordance with one embodiment;

FIG. 3 illustrates a system for synthesizing training imagery in accordance with one embodiment;

FIG. 4 depicts a flowchart of a method for synthesizing training imagery in accordance with one embodiment;

FIG. 5 illustrates a model training system in accordance with one embodiment; and

FIG. 6 depicts a flowchart of a method for synthesizing imagery in accordance with one embodiment

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

In the context of the present application, drawings such as mechanical drawings may refer to two-dimensional (2D) images such as those that are hand-drawn on paper or printed from CAD design tools. The majority of the geometric content (and typically all of the normative geometric content) comprises two-dimensional projections a part.

Although three-dimensional (3D) images of parts may help the reader visualize and interpret the part, 3D images are typically informative and not normative, particularly for parts designed before the adoption of 3D CAD systems or programs. In fact, it is still standard practice to produce 2D mechanical drawings for planning and fabricating a part for subsequent operations, inspections, etc. This is because 2D images store vital information such as dimensional tolerances, registers and datums, details that may affect fabrication, materials specifications, heat treatment instructions, finishing instructions, restrictive markings, markings relating to logistics or supply chains, or the like. Accordingly, a part often cannot be manufactured to specification without reference to these types of mechanical drawings.

An interested party such as a business enterprise may need mechanical designs or specifications for certain parts of interest. However, the only available designs or specifications for these parts are images of mechanical drawings. The enterprise may therefore need an automated method of extracting information from said images. Additionally, some manufacturing processes such as additive manufacturing, advanced computer numerical control (CNC), etc., require 3D representations or models of parts as data inputs to, for example, computer-aided machining (CAM), tool path planning, slicing computations, and the like. For parts where the only specifications are in the form of images of 2D mechanical drawings, converting such drawings to 3D representations is necessary—and typically performed manually—to effectuate manufacturing via such processes.

Each image of a mechanical drawing may comprise annotations and part geometry data that are linked. This makes it difficult for even computer vision systems to extract information from the images, as part geometry data and annotation data are superpositioned with each other. This information may refer to part geometry or other visual elements or the meanings. For example, a given line or arc in a drawing may represent a portion of part geometry or, alternatively, it could be a call-out or dimensioning annotation. Even a seasoned human reader may need to study a drawing for some time to understand the meaning of each visual element.

In the context of the present application, “part geometry” may refer to content of a mechanical drawing that is a rendering or visual representation of a part's physical form. For example, this may refer to an orthographic projection of the part. This content may describe or specify features such as bores, voids, concave regions, etc.

In the context of the present application, the term “annotation” or variations thereof may refer to content that is not part geometry. This may include elements such as the page frame and information block; and more complex elements such as text, symbols, measurements/dimension information, etc.

On the other hand, stains, stray marks, noise, artifacts of optical reproduction such as dirt on the bed of a photocopier or dust on a lens, etc. are not annotations. Handwritten marks on a copy of mechanical drawing may not be present in the source, but may be treated as normative or non-normative. In some embodiments, these types of marks may require further analysis.

The embodiments described herein provide novel techniques for partitioning or otherwise separating features of drawings. As described above, drawings such as mechanical drawings of components comprise geometric content and non-geometric content such as annotative content. The embodiments described herein may perform various processing steps such as, but not limited to, partitioning geometry data from other content; identifying and processing non-geometric content; associating orthographic projections and detail call-outs with other geometry; associating notes with referenced annotations or geometry; associating quantitative annotations, such as those associated with dimensions or tolerances, with the referenced geometry; correlating several drawings spanning multiple pages of a given part, and outputting results of such processing and analysis stage in one or more machine- or human-readable formats.

The embodiments described herein may analyze the partitioned geometry and annotations to, inter alia, understand the meaning of the annotations. As another example, the systems and methods described herein may perform 3D reconstruction for an object using the partitioned geometry and annotations.

Additionally, converting images of mechanical drawings to CAD models is a substantially manual process by trained or specialized personnel. Automating at least part of the conversion process as described herein can significantly reduce the labor required to complete and verify the conversion.

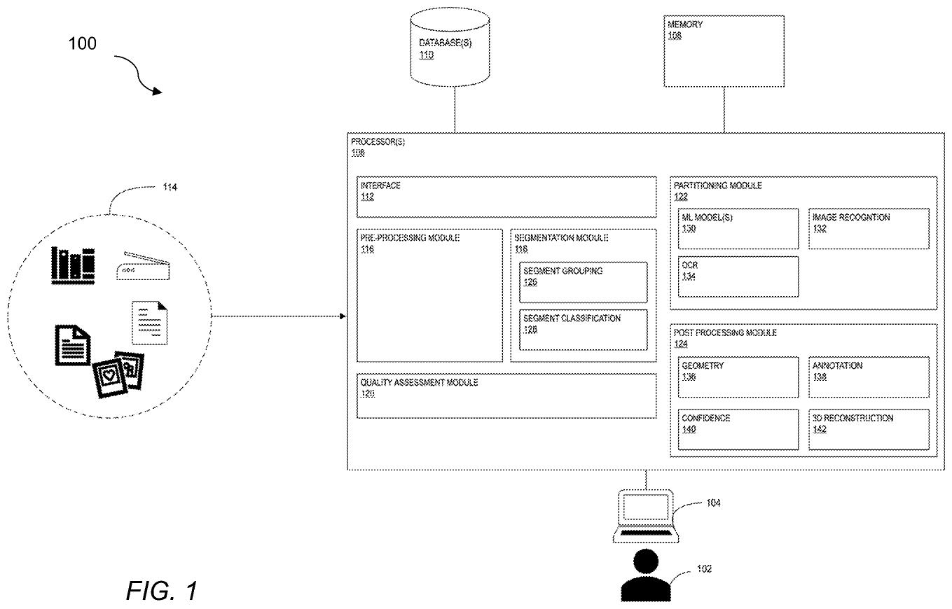

FIG. 1 illustrates an image partitioning system 100 in accordance with one embodiment. A user 102 may access a user device 104 for performing operations related to the described embodiments. The user device 104 may execute or otherwise be in operable communication with one or more processors 106 executing instructions stored in memory 108. In some embodiments, the “user” may comprise a machine or computer system, e.g., executing batch operations or functioning in an automated workflow.

The processor(s) 106 may be in further communication with or otherwise in operable connectivity with one or more database(s) 110. The databases 110 may store standards or guidelines associated with various standards or drawing guidelines, for example. The processor(s) 106 may include an interface 112 configured to receive imagery from one or more image sources 114. The interface 112 may be configured as a wired connection such as through Ethernet, Universal Serial Bus (USB), or other type of serial interfaces. Additionally or alternatively, the interface 112 may be configured as a wireless interface such as via Wi-Fi, near field communication (NFC), 4G or 5G, BLUETOOTH®, or any other type of interfaces whether available now or invented hereafter as long as the features of the disclosed embodiments may be accomplished

The processor(s) 106 may be any hardware device capable of executing instructions stored on memory 108 to accomplish the features of the disclosed embodiments. The processor 106 may include a microprocessor, a field programmable gate array (FPGA), an application-specific integrated circuit (ASIC), or other similar devices.

In some embodiments, such as those relying on one or more ASICs, the functionality described as being provided in part via software may instead be configured into the design of the ASICs and, as such, the associated software may be omitted. The processor 106 may be configured as part of the user device 104 (e.g., a laptop or desktop) or located at some remote location.

The processor(s) 106 may receive one or imagery items from the image sources 114 over one or more networks. The network(s) may link the various components with various types of network connections. The network(s) may be comprised of, or may interface to, any one or more of, and without limitation, the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1, or E3 line, a Digital Data Service (DDS) connection, a Digital Subscriber Line (DSL) connection, an Ethernet connection, an Integrated Services Digital Network (ISDN) line, a dial-up port such as a V.90, a V.34, or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

The network or networks may also comprise, include, or interface to any one or more of, and without limitation, a Wireless Application Protocol (WAP) link, a Wi-Fi link, a microwave link, a General Packet Radio Service (GPRS) link, a Global System for Mobile Communication (GSM) link, a Code Division Multiple Access (CDMA) link, or a Time Division Multiple access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based link

The image sources 114 may refer to any source of an image of a drawing. A source may refer to, for example and without limitation, journals, books, magazines, pictures, academic papers, catalogs, manuals, or the like. In some embodiments, imagery may be scanned by a scanner and provided to the processor(s) 106 via the interface 112.

The processor(s) 106 may execute computer executable instructions to provide various modules involved in at least portioning imagery in accordance with the embodiments described herein. These may include a pre-processing module 116, a segmentation module 118, a quality assessment module 120, a partitioning module 122, and a post processing module 124.

Upon receiving one or more imagery items (for simplicity, “image” or “imagery item”), the pre-processing module 116 may perform one or more operations to improve the accuracy, correctness, performance, or some combination thereof, of subsequent steps. The pre-processing module 116 may execute various submodules to perform some designated operation(s) on received images.

These pre-processing operations may include operations related to resizing, scaling, sharpening, noise reduction, despeckling, color or contrast adjustments, color space conversions, rendering of a vector or partially-vector input image into a bitmap image, edge detection, filtering, or the like. In some embodiments, the pre-processing module 116 may output one or more images as well as metadata.

The segmentation module 118 may identify and label one or more segments of the received image. A segment of an image may refer to a subset of pixels of the image, which are typically contiguous in pixel space. In some embodiments, a segment may comprise a non-contiguous set of pixels.

The type of segments identified may vary and may depend on the content of the image. For example, if the image is of a mechanical drawing that includes multiple orthographic projections of a part, the segmentation module 118 may identify image segments comprising each such projection.

The segmentation module 118 may execute a segment grouping submodule 126 and a segment classification submodule 128. The segment grouping submodule 126 may group segments according to labels assigned to each segment. A segment may comprise a closed polygon, a rectangular region, a closed region defined by parametric curves, or similar description or definition. In some embodiments, the union of the segments outputted by an image segmentation step covers (is equal to) the input image. In some embodiments, segments may be disjoint, may overlap, or may share one or more edges. In some embodiments, a segment may comprise multiple sub-segments. In some embodiments, a segment may be associated with other segments, for example directly or explicitly, via geometric position, or via metadata.

The segment classification submodule 128 may classify one or more of the identified segments. For example, in some embodiments, the segment classification submodule 128 may assign to a segment a classification of “orthographic projection,” “isometric projection,” “legend,” “notes,” or “unknown.”

In some embodiments, classifications may fall into equivalence classes comprising “annotations only” and “annotated drawing,” the latter being understood to comprise a combination of geometry and possibly annotations or parts of annotations. The classifications “orthographic projection” and “isometric projection” would be in the annotated drawing equivalence class.

In some embodiments, an image partitioning step may comprise an output comprising or describing regions of the input image for which partitioning is indeterminate or low confidence, cannot be calculated, or where partition membership is undefined. The quality assessment module 120 may assess or identify whether the quality, fidelity, or other aspects of an image are of sufficient quality for subsequent processing or analysis. For example, an image may be of such low quality that subsequent analysis is not possible, such as if the image is damaged or has suffered from excessive generational loss, such as from repeated photocopying. In such instances, the system 100 may be configured to abort processing of the image or otherwise reject an image. In some embodiments, a rejected image may be referred to another system or a human for further analysis or processing.

In some embodiments, the quality assessment module 120 may instruct other components of the system 100 to “ignore” regions of an image. An output of the quality assessment module 120 may comprise information about such rejection or otherwise the ignored regions, such as characterization, qualification, or quantification of the cause(s) of such rejection or ignorance. In some embodiments, the output of the quality assessment module 120 may further comprise confidence metrics. In some embodiments, the quality assessment module 120 may reject or flag an image due to restrictive markings, notations that the image is deprecated, or based on other criteria. The functionality provided by the quality assessment module 120 may instead be performed by one or more of the other components of the system 100.

The partitioning module 122 may provide an output comprising or describing the annotation partition and the geometry partition of the image. The union of the annotation and geometry partition outputs may cover or equal the image input. In some embodiments, the annotation and geometry partitions may be disjoint or may share one or more edges. Each output partition may be denoted as a mask, bitmask, or equivalent over/of the image input. In the context of the present application, the output may refer to a bitmap, raster, a vector representation, a parametric representation, a 3D representation of a visual image, etc.

The partitioning module 122 may execute an ensemble of one or more models or algorithms including machine learning model(s) or algorithms. These may include, for example and without limitation, one or more machine learning models 130, an image recognition module 132, and an optical character recognition (OCR) module 134. These models, techniques, modules, or algorithms may be executed individually or severally, sequentially or in parallel, as compositions or in isolation, and with feedback or feed-forward routines. In some embodiments, the functionality provided by these individual modules may be combined into single module or process.

The partitioning module 122 may preform steps related to partitioning the geometry of the part from other content, identifying and processing non-geometric content, associating orthographic projections with axes, associating call-outs with geometry, correlating multiple drawings a part that span multiple pages, or associating notes with referenced annotations or geometry. Processing the input images may also include associating quantitative annotations (e.g., those associated dimensioning or tolerances), with the referenced geometry. Processing the input images may also include outputting results of such processing in one or more machine- or human-readable formats.

The machine learning model(s) 130 may include convolutional neural networks (CNNs), deep learning, neural networks, state vector machines (SVMs), k-means, spectral/frequency domain analysis, or spatial analysis models, imaging computations, computational geometry. These models 130 may further include random forests or decision trees, or any other computer vision or machine vision technique whether available now or invented hereafter.

The image recognition module 132 may execute one or more procedures to analyze pixel data of an image to identify objects within the image. These techniques may include feature-based methods such as Scale-Invariant Feature Transform (SIFT), Histogram of Oriented Gradients (HOG), Speeded Up Robust Features (SURF), or the like.

The OCR module 134 may execute one or more OCR-based techniques to identify textual content or machine-readable text. These may include pattern recognition techniques, matrix matching techniques in which characters in an image are compared against stored pixel groups, intelligent character recognition techniques to comprehend handwritten text, intelligent word recognition to identify words, or transformer-based OCR techniques.

The post-processing module 124 may receive as an input one or more image partitions outputted by the partitioning module 122. Post-processing techniques may involve using one or more of the image processing methods described above with respect to the input image preprocessing step. The post-processing step(s) may also involve calculating alternative representations of an image or a subset of its content, such as calculating a representation of shapes as sets of vertices and edges or curves.

Some embodiments of post-processing may comprise segmentation or classification. In some embodiments, a post-processing step's input(s) may comprise segmentation outputs from a previous step. In some embodiments, a post-processing step may retain, or its outputs may comprise, data regarding the location or position of a feature or visual element in the image partition, a segment, or the input image or relative to other features, visual elements, or segments.

The post-processing module 124 may include or otherwise execute a geometry submodule 136, an annotations submodule 138, a confidence submodule 140, and a 3D reconstruction submodule 142. The functions provided by the geometry submodule 136 and the annotations submodule 138, discussed below, may be performed independently, jointly, or both, depending on the embodiments. Some embodiments may comprise multiple post-processing steps. In some embodiments, a post-processing step may comprise writing data to or reading data from storage, another process, or a remote system or synchronous or asynchronous interactions with the user 104.

The geometry submodule 136 may, in some embodiments, convert the image content to another representation such as a graph, a mesh, a triangularization representation, etc., or any other type of representation suitable for subsequent analysis or processing. The geometry submodule 136 may identify occluded features such as the use of dashed or broken lines, as well as certain geometry-relevant indicia such as hole centers, centers of radiused features, bevels, curved surfaces, or the like. This data may be converted to or used as metadata in interpreting part geometry or in reconstruction.

The geometry submodule 136 may be configured to identify and process a drawing's scale, wherein the scale may comprise an input to a post-processing step. Mechanical drawings are typically to scale such that all views of a part are at the same scale with respect to each other, or that the size of the drawing is related to the size of the corresponding part according to a particular ratio.

For example, some drawings are 1:1 but other drawings may be scaled up or down. Architectural drawings, for example, may be scaled to 1:12, such that one inch on the drawing equals one foot on the structure. A drawing's scale is typically indicated expressly as markings on a drawings, such as the drawing's frame, and comprise scales in the drawing's dimensional units. When scale data is known, the geometry submodule 136 may convert image coordinates (e.g., pixel coordinates) to spatial coordinates or lengths (e.g., inches or millimeters), possibly retaining image coordinates to preserve precise correspondences with an image.

Depending on the spatial resolution of images of mechanical drawings, the geometry submodule 136 may defer analysis or application of scale-related information. For instance, the spatial resolution of images of mechanical drawings may be insufficient to accurately or precisely represent or encode the dimensional specifications of a part. Even with sufficient spatial resolution, noise or optical effects may lead to at least some uncertainty about measurements derived solely from geometric information. Instead of deferring analysis in this case, the geometry submodule 136 may estimate and record dimensional or uncertainty within some tolerance or percentage error.

In some embodiments, the post-processing steps described herein may be performed on projections of a part, such as the part's orthographic or isometric projections. The geometry submodule 136 may identify a particular view or direction of a projection, groupings of projections, components of an assembly, or the like.

The geometry submodule 136 may leverage records stored in the databases 110 of drawing conventions to infer projections based on, for example, a view's position relative to other views of the same part. Some embodiments may process one or more isometric projections of a part and rely on isometric projections to identify, refine, verify, or disambiguate inter-view correspondences or relationships.

The geometry submodule 136 may in some cases ignore isometric views if the views are non-normative or if the isometric projections should be or must be sufficient to extract a part's geometry. Some embodiments may be configured to infer or otherwise calculate a projection and attendant part geometry of a part not present in a drawing, such as the cross-section of an unbent sheet metal part, or a secondary axis projection of a radially symmetric part, such as a shaft.

The geometry submodule 136 may identify the relationship between a call-out detail or detail view with an associated projection and, in some embodiments, may combine the detail with the projection. These call outs or detail views typically comprise enlarged views of a portion of a part. The content of such detail views is typically normative but the depicted features may be too small to be specified visually at the scale of the entire part.

Post-processed 2D part geometry may be stored or encoded in a CAD format. In some embodiments, the CAD format may be re-rendered into an image format (CAD image) and may be compared with the geometry partition, which should be essentially identical if processing was correct. Discrepancies between the geometry image and the CAD image typically will indicate errors in the geometry post-processing or, in some instances, may be indicative of stray or irrelevant artifacts in the geometry image. In some embodiments, this validation step may feed back into upstream steps which may be re-executed, e.g., in light of identified errors, or as part of a training feedback loop.

The geometry submodule 136 may calculate the difference between a geometry image and a CAD image, e.g., as a difference image. The difference image may be outputted by a post-processing step or later step in the system 100 or associated methods.

In some embodiments, the confidence submodule 140 may calculate a confidence score for each part or each reconstructed view of a part and, in some embodiments, such confidence score may be calculated based on the difference between a geometry image and a CAD image. Some embodiments may be configured to ignore certain geometry image content, such as hole or curve center markings, when calculating difference images or confidence scores.

The geometry submodule 136 may also detect errors in partitioning or other processing of an input image, such as if there is an annotation in a geometry partition. In some embodiments, the geometry submodule 136 may reference an output from the annotation submodule 138 to further analyze or correct any errors.

Some errors may relate to part geometry that cannot exist in a correct mechanical drawing. An example of this type of error is a drawing with a hole in empty space or a drawing with a feature of zero thickness. Another example is if the dimensions of sub-components of a region do not add up to the indicated dimension of the region; this could be an indication of errors in processing or errors in the original drawing itself. The geometry submodule 136 may also reference a reconstruction generated by the 3D reconstruction submodule 142, discussed below, to confirm or identify any errors.

The annotation submodule 138 may analyze annotations relating to or with reference to part geometry to, inter alia, at least detect correct errors, inconsistencies, or extracted values that may otherwise be impossible. In some embodiments, the annotation submodule 138 may process annotations during or following the processing of part geometry by the geometry submodule 136. The relationships between or among annotations may be identified, at least in part, through analysis of annotations'locations relative to part geometry, textual or symbolic content, or visual elements.

The annotation submodule 138 may take action based on metrics associated with the extracted annotations. These metrics may refer to a confidence metric such as one calculated by the confidence submodule 140 or returned by any one or more of the processing steps of the partitioning module 122.

These metrics may enable the annotation submodule 138 to make decisions based on the plausibility or accuracy of returned annotations. For example, a part with a high confidence maximum linear dimension of 100 mm accompanied by an annotation indicating a hole therein with a radius of 200 mm cannot exist. Accordingly, the annotation submodule 138 may conclude that the extracted radius is incorrect, and that the radius may be 20.0 mm instead. Such inference may, in some embodiments, be informed by upstream pre-preprocessing analysis. For example, if high levels of noise were detected during pre-processing, then the previous example of the misplacement of a decimal point may be treated as a higher-probability resolution of the inconsistency/error or the confidence of the correction may be reported as higher (compared to the case where the input image has low noise).

As another example, the relative locations of features along an axis of a part cannot cumulatively place a feature outside the part or in a position distant from where it is shown in an image. As yet another example, three holes located according to their centers'distances from the left edge of a part cannot be at positions 10.0 mm, 250 mm, and 50.0 mm (regarded left-to-right). In this case, the annotation submodule 138 may conclude that at least one of the second and third locations is incorrect, possibly because “25.0” was read as “250” or because the dimensioning marks for the respective locations were misinterpreted when analyzing the respective annotations.

The annotation submodule 138 may analyze annotations with respect to multiple projections or illustrations of part geometry. The annotation submodule 138 may leverage one or more illustrations of part geometry to, for example, verify that dimensioning indica for the same part or feature is consistent across multiple views of the part.

The annotation submodule 138 may perform this verification by identifying feature correspondences among multiple views of the part, such as a common edge of a part, or the correspondence between axial and radial projections of hole. Accordingly, the annotation submodule 138 may rely on output from the geometry submodule 136 in assessing annotations.

In some embodiments, the annotation submodule 138 or other component may autonomously correct any discrepancies or errors. Alternatively, the annotation submodule 138 or other component may flag the error and issue an alert to the user 102 for review.

The annotation submodule 138 may recognize symbolic information and associate it with aspects of part geometry they describe. This symbolic information may relate to angular specifications, radius specification, view information, datums, registers, material specifications or characteristics, etc. In some embodiments, dimensioning and other marks or indicia may comprise a plurality of lines that associate a numerical quantity with certain part geometry. The annotation submodule 138 may distinguish such lines from part geometry during or before partitioning. The annotation submodule 138 may also be configured to revise partitioning or segmentation according to interpretation of or inference about dimensioning or other marks during post-processing of annotations or parts. A given quantity's value, such as a length or angle, may be expressly or implicitly defined according to multiple values, such as in the case of a tolerance value applied to a dimension and, in some embodiments, such values may be combined or grouped or expressed in metadata.

Some drawings may conform to certain industry standards for the symbolic or visual representation of annotations and may include indicia of the same. In some embodiments, the annotation submodule 138 may identify such indicia and knowledge of the applicable industry standard(s) may be used to guide, assist, or direct inference about annotations in such drawings.

Some annotations may not be directly related to part geometry, or may describe non-geometric aspects of a part or a component thereof. The annotation submodule 138 may nonetheless identify or process notes, engineering notes, process information, finishing information, etc. which may or may not refer to part geometry directly or whose relationship to part geometry is descriptive or requires the interpretation of natural language. Some embodiments may be configured to identify or process decorative or informational annotations, such as document/page frames, title blocks, tables, revision histories, signatures or approval stamps or seals, parts lists, assembly manifests or specifications, etc., or annotations that otherwise pertain to a mechanical drawing itself (e.g., metadata) but may not affect part geometry.

Some drawings may comprise markings, such as restrictive markings used by governments or in conjunction with proprietary or copyright markings, distribution statements, or the like.. The annotation submodule 138 of some embodiments may expressly identify such markings, which may influence further processing, storage, handling, encipherment, rejection, flagging, or other policies attendant to such markings. For example, if a drawing marked SECRET were being processed by a non-SECRET system, processing might be aborted, a policy violation may be reported, or other corrective actions may be taken.

The confidence submodule 140 may provide an output indicating confidence in each partition. The outputted confidence may refer to the confidence in particular regions, such as on a per-segment basis or on a per-pixel basis. In some embodiments, the confidence submodule 140 may output a scalar quantity that represents the overall confidence in a partition. In some embodiments, the confidence submodule 140 may output an ordinal or value of an enumeration, or a more complex data structure to represent the confidence.

The confidence may be expressed as a heat map comprising a plurality of pixels, wherein the color or otherwise the value of each pixel indicates the partitioning confidence in the corresponding pixel or region of the input image. The confidence may be proportional to or otherwise indicate the probability that the classification of a region or pixel as geometry, annotation, or, in some embodiments a classification of both. In some embodiments, the outputted confidence may be expressed as a vector of confidence quantities of dimension two or three (i.e., the number of possible classifications), where each dimension corresponds to a classification confidence. For example, the vector [0.1, 0.95, 0.9] might denote that the probabilities that the given pixel or region is in category geometry, annotation, or both are 10%, 95%, and 90%, respectively. Such quantitative confidence measures may be accessible to users or other systems, may be recorded to durable storage or external services, may be ingested by analytic or reporting systems, or may be included as metadata with the outputs of the processing pipeline.

The 3D reconstruction submodule 142 may leverage output from the geometry submodule 136, the annotation submodule 138, or both, to generate a 3D representation of the part. The 3D reconstruction submodule 142 may leverage knowledge of scale, orientation, points-of-correspondence of multiple views to calculate the 3D locations of respective points.

The 3D reconstruction submodule 142 need not rely on any specific method or procedure for identifying points-of-correspondence between drawings. In accordance with the described embodiments, the 3D reconstruction submodule 142 will typically require at least two projections of an object according to distinct or calculatable views, and a plurality of points-of-correspondence among a pair of projections.

Some embodiments may comprise post-processing of part geometry after the 3D reconstruction submodule 142 generates a 3D representation. The 3D reconstruction submodule 142 may refer to annotations when determining or identifying points-of-correspondence among 2D projections. Annotations related to a part or component length will be associated with at least two distinct points on the part geometry, many of which will be depicted in at least one other view.

In some embodiments, the 3D reconstruction submodule 142 may rely solely on the visual or geometric content of the drawings. Once the 3D reconstruction submodule 142 calculates the 2D-to-3D transformation, the 3D coordinates of other points can be calculated directly from the 2D projections to provide a denser mesh or to quantize curves.

In some embodiments, a vertex of a 3D representation of a part may comprise or be associated with metadata relating to the origin of the vertex in the two or more 2D projections, annotations relevant to the vertex, confidence score(s) applicable to the vertex, or other relevant data. The precise dimensions of a 2D projection may be calculated with reference to processed annotations and prior to 3D reconstruction. Some embodiments may retain or preserve 2D representations of each view to allow for further fine-tuning of the 3D reconstruction. In some embodiments, a 3D representation of a part may be outputted or otherwise stored or encoded in a CAD format. In some embodiments, reprojected orthographic or isometric projections of a 3D representation of a part may be rendered and compared to corresponding views of the part from the input image(s) or geometry partition(s).

In some embodiments, errors, discrepancies, or ambiguities identified in the geometry partitioning, annotations partitioning, or 3D reconstruction steps may feed back or forward to other steps that may provide or require further information or for which further processing or reprocessing may be required to resolve such errors. This essentially creates an iterative process that occurs until all such errors, discrepancies, or ambiguities have been resolved. Unresolved errors, discrepancies, or ambiguities may lead to rejection of an input image, suspension of processing, flagging of certain outputs, or requests for user assistance or intervention. Identified issues relating to errors in a given step's processing or calculations may lead to reconfiguration or retraining of a step or a component thereof.

Some embodiments may incorporate user assistance or user input at any stage of image or geometric analysis during processing, a priori, or ex post. In embodiments where the reconstructed 3D representation may be intended for use in manufacturing the part, a human, such as a mechanical engineer or other subject-matter expert, may inspect the 3D representation with reference to the original drawings, to verify its correctness. They may also make corrections, possibly informed by the outputs of the process herein described, such as noted errata, confidence measures, etc. In some embodiments, the results of such human inspection and correction of the system's outputs may be fed back into the system 100 to, for example, further train or tune models. Thus, the feedback of the systems taught herein may comprise inputs from computations, human inputs, or both.

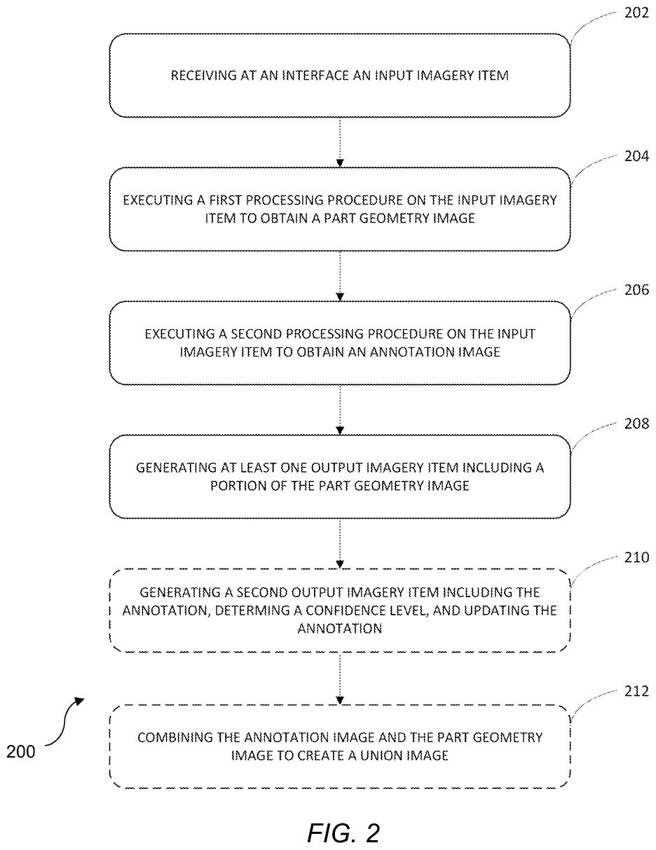

FIG. 2 depicts a flowchart of a method 200 for processing imagery in accordance with one embodiment. The system 100 of FIG. 1 or components thereof may perform the steps of method 200.

Step 202 involves receiving at an interface an input imagery item, wherein the input imagery item includes a mechanical drawing of a part. The interface may refer to interface 112 of FIG. 1, for example. The image may be received from any type of image source such as journals, magazines, books, catalogs, etc.

Step 204 involves executing, using one or more processors executing instructions stored on memory, a first processing procedure on the input imagery item to obtain a part geometry image from the input imagery item. Step 206 involves executing, using the one or more processors executing instructions stored on memory, a second processing procedure on the input imagery item to obtain an annotation image from the input imagery item. The partitioning module 122 of FIG. 1 may execute one or more of a variety of procedures to perform steps 204 and 206.

Step 208 involves generating, using one or more processors executing instructions stored on memory, at least one output imagery item including a portion of the part geometry image. In some embodiments, the output imagery item may be a three-dimensional representation of a part. In some embodiments, the method 200 may include a post-processing step involving providing the output imagery item with vertices and edges of the part.

As described herein, a “visual rendering or representation” of semantic information may comprise an image that is directly visualizable, such as a 2D image, photograph, or drawing. Additionally or alternatively, a representation may comprise an image whose visualization may require or be assisted by further computation, such as a 3D model, video/movie clip, animation, etc., individually or severally. A view discernable to a human may require the use of display technologies, such as computer monitors, 3D headsets, projectors, holography, oscilloscopes, etc. The creation of physical objects such as through printing, machining, or additive manufacturing/3D printing, or any other technique whether available now or invented hereafter, may be used in conjunction with the described embodiments. An “image” may, in some embodiments, be perceptible as sound or touch, such as through audio or haptic output devices and the teachings herein may be useful in connection with non-visual renderings or representations, notwithstanding the use of image-related vocabulary herein.

Step 210 involves generating a second output imagery item including the annotation image, and determining a confidence level in an annotation of the annotation image. The confidence level may be based on the likelihood the annotation accurately describes some aspect of a part, for example. However, in some embodiments, the textual content may be unrelated to part geometry. Step 210 may further include the step of updating the annotation upon determining the confidence level is below a threshold.

Step 212 involves combining the annotation image and the part geometry image to create a union image. Assuming processing of the above steps was correct, the union image is identical to the input imagery item within a specified tolerance.

The above discussion relates to processing imagery using one or more models. A frequent impediment in model development in accordance with existing techniques is obtaining appropriate training data to build a useful or sufficiently accurate model. In dealing with mechanical drawings specifically, this impediment is particularly profound in dealing with mechanical drawings due to the diversity of drawing conventions, styles, and tools used over many decades, some of which were digital and some of which were hand-drawn. For example, training data and ground truth data may be entirely unavailable with older drawings.

Although training data can be created manually, this process is time-consuming and expensive. Manually-created training data sets can also include errors, thereby degrading the model quality and accuracy.

The embodiments described herein, on the other hand, produce known, correct inputs and outputs for a model. These outputs may be used for various types of imagery processing steps or procedures, such as those performed by the partitioning module 122 of FIG. 1. For example, the output of the training steps described herein may be stored in the databases 110 of FIG. 1 to be used in conjunction with the previously described partitioning processes.

The systems and methods taught herein generalize to a variety of applications and are applicable to a wide range of training use cases to, for example, mitigate scarcity of training data or the limitations of data augmentation schemes. For the avoidance of doubt, the systems and methods taught herein are not data augmentation—they are the synthesis of new training data based on precisely-known priors. Additionally, these methods are not generative—in the sense of generative AI systems—as the disclosed methods are deterministic.

The data used in the training or validation of models or other components in some embodiments may comprise one or more of manually-labeled or manually-created priors, synthesized training data, rendering of known digital content, or other sources. In accordance with the described embodiments, a received training imagery item may comprise a visual rendering or representation of a set of information. In the context of the present application, this information may be referred to as semantics or the “semantic content” of the meaning. For example, the semantic content of a bar graph may comprise a set of quantitative values or numbers. As another example, the semantic content of a mechanical drawing of a part may comprise the dimensional and manufacturing specifications of a part.

Another aspect of an imagery item is its style. In the context of the present application, “style” may refer to an imagery item's syntax or visual form, which may be a function of artistic and/or aesthetic characteristics. Style may also comprise choice of fonts or aspects of handwriting or hand-drawn visual syntax. The style of a given image may be according to one or more standards, style manuals, or guidelines, such as the style guidelines of a scholarly journal or industry standards for mechanical drawings. Styles may comprise aspects of 2D or 3D rendering, such as texture mapping, lighting, surface properties (such as reflectivity, transparency/translucency, specularity, or refraction), camera or optical effects, such as radial distortion or lens flares, shadows, fog or smoke, etc.

The types of training images may vary. Training images may comprise imagery of the natural world, such as satellite photographs, synthetic aperture radar (SAR) imagery, or imagery obtained from light detection and ranging (LIDAR)-based tools. Some images, such as LIDAR, may comprise encodings or representations of more than two spatial dimensions, multiple spectra, or other positionally-referenced data. For example, both LIDAR and SAR can detect or measure the shape of imaged terrain. As another example, some “imaging” may comprise measurements by gravitometers, magnetometers, infrared or ultraviolet sensors, RADAR, or the like. Some types of imagery may comprise composites of the data of multiple sensors or sources.

In some embodiments, synthetic images of the natural world may be created from models or simulations of the natural world. For example, these models may include terrain models or models of buildings or vehicles (i.e., their semantic content), together with simulations or computational embodiments of one or more sensor or imaging methods forming the styles.

Some embodiments may further comprise the insertion or application of noise sources to model or simulate real-world noise sources such as scintillation, ionospheric effects, cloud cover or other meteoritical effects, pollution, smoke, etc. In some embodiments, noise sources may emulate noise associated with analog-to-digital conversion, generational loss, photographic/lens distortion, etc.

Noise, at least in some contexts, is correctly-associated with “randomness” such as the noise associated with analog processes, and often originates from intrinsically random physical processes. However, the insertion or application of noise sources in embodiments described herein may comprise pseudo-random “noise sources,” such as pseudo-random number generators (PRNGs). A PRNG outputs data that appears statistically random but is calculated using deterministic algorithms. For example, some PRNGs are initialized with a “seed” and, for a given seed, will output the same sequence of bits. Such embodiments therefore add content that, from a signal-processing standpoint, is “noise” but is, for the purposes taught herein, deterministic.

In some embodiments, models or simulations of the natural world may be configured to model or simulate time-variant content, such as the movement of vehicles or humans, tides, the progression of a forest fire, etc. These embodiments may be configured to synthesize or create a series of synthesized images taken over some time interval. These and other synthetic imagery may comprise encodings or representations of more than two spatial dimensions, multiple spectra, other positionally-referenced data, or other content that may typically be in the particular type(s) of imagery in question.

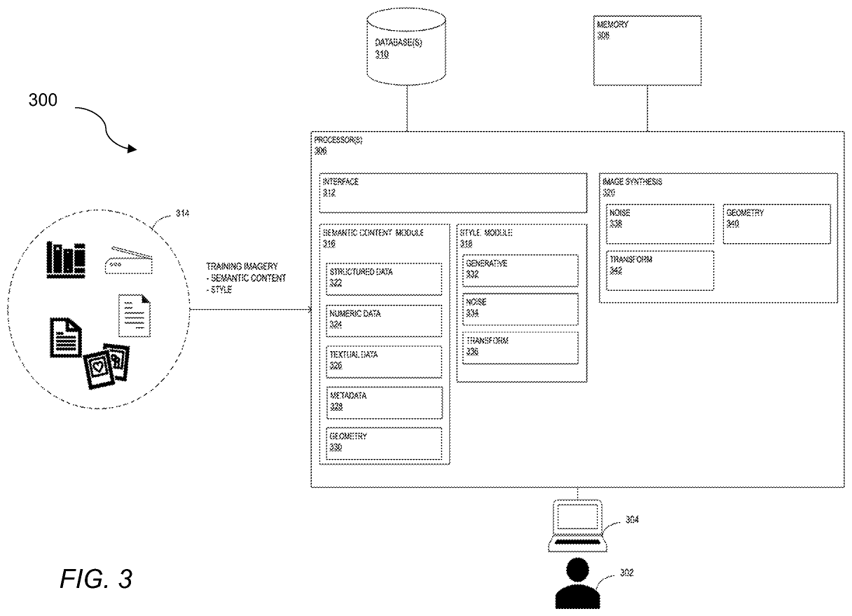

FIG. 3 illustrates a system 300 for creating training imagery in accordance with one embodiment. The created training imagery may be implemented in computer image processing systems such as those described herein. For example, the imagery processing systems and methods described herein may comprise one or more methods that require some degree of model training, such as the machine learning models 130, algorithms, or the like discussed in conjunction with FIG. 1.

The system 300 may be similar to the system 100 of FIG. 1 and may include similar components. A user 302 may access a user device 304 for performing operations related to the described embodiments. The user device 304 may execute or otherwise be in operable communication with one or more processors 306 executing instructions stored in memory 308. The processors 306 and memory 308 may be configured similarly to the processors 106 and memory 108, respectively, of FIG. 1.

The processor(s) 306 may be in further communication with one or more database(s) 310. The processor(s) 306 may include an interface 312 configured to receive training imagery from one or more image sources 314 or databases 310. The interface 312 may be configured similarly to interface 112 of FIG. 1.

The image sources 314 of training data may refer to any source of or providing an image of a drawing. A source may refer to, for example and without limitation, journals, books, magazines, pictures, academic papers, catalogs, manuals, or the like. In some embodiments, imagery items may be scanned by a scanner and provided to the processor(s) 306 via the interface 312.

The processor(s) 306 may execute computer executable instructions to provide various modules involved in generating training imagery in accordance with the embodiments described herein. These may include a semantic content module 316 to analyze the semantic content of imagery, and the style module 318 to analyze style content of imagery.

The input training imagery data may comprise known semantic content and styles. The semantic content module 316 may analyze the received semantic content of imagery and the style module 318 may analyze the received style data of the of the training imagery. In some embodiments, the semantic content module 316 may be configured to extract data regarding an imagery item's semantic content, and the style module 318 may be configured to extract data regarding the style of an imagery item.

As discussed above, the semantic content of an imagery item may be a bar graph or the geometry of a mechanical part specified in a drawing. In the context of a graph, the semantic content may include a data series. The style of the imagery item may refer to the type of graph or chart, the general appearance of the graph, colors used in the graph, or the like. In some embodiments, the received semantic content may comprise a CAD file. The CAD file may comprise 2D models, 3D models, or some combination thereof, of one or more parts.

Imagery and the visualization thereof is but one of multiple ways to interpret or understand the semantic content of an underlying object and there are often multiple visual interpretations of an object. For example, a data series could be represented as a data table or a spreadsheet—as pure text—which could be viewed as visual or as purely data. Likewise, a precise description of a drawing or an object (its semantic content) could be rendered purely as prose. The salient point is generality: the semantics of the object itself need not be intrinsically visual and a visual representation need not be intrinsic to the underlying semantic content.

The semantic content module 316 may execute one or more submodules to analyze various aspects of semantic content of an imagery item. These may include, but are not limited to, a structured data submodule 322, a numeric data submodule 324, a textual data submodule 326, a metadata submodule 328, and a geometry submodule 330.

The structured data submodule 322 may analyze structured data associated with an image. The structured data may include technical data such as an image's format, size, color space; EXIF data such as orientation and timestamp; or descriptive data such as textual content or captions. Structured data may comprise geometric descriptions of an object, such as a graph, mesh, CAD representation, 3D model, sequences of constructions, parametric curves, etc. which, in some embodiments may be parameterized. In some embodiments, such structured data itself may be synthesized, e.g., programmatically and with perfect knowledge of its semantic content.

The numeric data submodule 324 may analyze data related to, for example, pixel-related data. This pixel data may include pixel values denoting their color, grayscale intensity values, size of an image in terms of pixel width and pixel height, etc.

The textual data submodule 326 may identify or otherwise analyze various textual aspects regarding an image. This may include text that is physically present in an image or text extracted from an image such as through OCR. Textual data may be provided as input directly (i.e., separate and apart from an image) and, in some embodiments may be synthesized in like manner to or in conjunction with structured data.

The metadata submodule 328 may analyze various other aspects or metadata associated with an image. The geometry submodule 330 may analyze various representations of encodings of geometric data. These may refer to coordinates, vector encodings, matrix encodings, equations, graph-based encodings, or the like.

The above modules 320-30 are exemplary and the semantic content module 316 may analyze various other aspects of semantic content associated with an image. For example, the semantic content module 316 may analyze representations or encodings of geometry or visual elements, the enumeration values or ordinals, or the like. The type of content analyzed may vary and may depend on the type of image being synthesized.

In some embodiments, the input semantic content may comprise machine-readable instructions or code for the generation of definite values, such as an encoding of instructions to “draw a rectangle of width 10 to 100 units and height 20 to 50 units”, “generate a random string according to this regular expression”, or “vary the radius of this arc by ±10 mm”. Some embodiments may comprise semantic content synthesizers that construct semantic content according to, without limitation, configuration, inputs, instructions, generators or generative methods or algorithms, trainable methods or trainable algorithms, and transfer learning. In some embodiments, the outputs of such synthesizers are definite (known priors) despite having been synthesized, at least in part, by non-deterministic methods (such as generative methods). That is, once synthesized, the semantic content is definite and deterministic notwithstanding stochastic aspects of its synthesis.

The style module 318 may analyze the received styles associated with one or more imagery items (semantics). The style module 318 may be configured to vary one or more aspects of its rendering of semantic content, for example, by varying a handwriting style, enabling or disabling gridlines, varying symbolic lexicons, or varying the dimensions of the output image. The application of the style to the semantic is deterministic. This ensures that the rendered image is consistent with a ground truth, as opposed to generative-based techniques.

In some embodiments, styles may be leveraged to merge multiple semantic content elements or to render semantic content implicitly instead of explicitly. In some embodiments, a style may be configured to omit certain semantic content, for example, because the style being synthesized does not comprise visual syntax for such content or such content is forbidden (e.g., by an underlying standard or convention). Such omissions may not comprise errors when assessing the outputs of such embodiments, particularly if the style is known when assessing or verifying interpretation of an image in said style.

Some embodiments of styles may comprise generative algorithms 332 or generative methods. However, the output image is deterministic. Some embodiments of styles may comprise trainable algorithms or trainable methods and, in some embodiments, may comprise or use transfer learning. Some styles may be defined parametrically, such as by configuring a more generalized style to use certain visual syntax or a more specific variant of a generalized style.

A noise submodule 334 may apply some degree of noise to the semantic content, such as through the use of PRNGs as discussed above. Noise may impair comprehension or interpretation of semantic content and is not considered part of the semantic content or style of an image. For a given quantity of noise, the magnitude such impairment may be dependent on the choice of style (e.g., font size, line width, shading, or redundancies).

A transform submodule 336 may apply one or more transforms in applying a style. These may include a parametric or parameterized transform, which may comprise an anisotropic transform, radial distortion, spherical distortion, convolution, or the like.

The image synthesis module 320 may be configured to output an image according to the semantic content and an input style. In other words, the image synthesis module 320 may output one or more images, wherein each image is a rendering of the input semantic content according to a style. In some embodiments, one or more of the decisions, mutations, or inputs to the same performed by or used by a style may be recorded, e.g., as metadata, and made available as part of the ground truth or other outputs of this process.

In some embodiments, the image synthesis module 320 may execute a noise submodule 338 to add noise to an output image. In some embodiments, the image synthesis module 320 may output a plurality of images, wherein each image has a different quantity or type of noise added.

The noise submodule 338 may be configured to add noise to a generated image that is similar to noise associated with images in general or “born-analog” images. The latter of these types of images may experience noise due to photocopying, water stains, tears, ink or pencil marks, rescaling or resampling, optical distortions consistent with certain photographic duplication methods or processes, etc. The noise submodule 336 may add noise as a style. As previously discussed, noise sources may be PRNGs or other “algorithmic” or “deterministic” or “predictable” noise sources. The noise itself, which is known to the system, may be recorded and included, e.g., as metadata, and made available as part of the ground truth or other outputs of the system. Recording of the output of a noise source—and therefore ground truth knowledge of such noise, allows the use of true random number generators (TRNGs), such as a hardware random number generator (HRNG), cryptographically-secure random number generator (CSRNG), or quantum random number generator (QRNG), or other nondeterministic entropy sources.

In some embodiments, the image synthesis module 320 may execute a geometry submodule 340. The geometry submodule 340 may be configured to receive as an input a CAD drawing or file. In these embodiments, the geometry submodule 340 may output at least one of a mechanical drawing and at least a subset of the input or one or more partitions thereof.

As discussed in conjunction with FIG. 1, the output of the image synthesis module 320 may include a geometry partition or an annotation partition. The geometry submodule 340 may render partitions by modifying various parameters related to rendering processes or the CAD software in general. For example, the geometry submodule 340 may enable, disable, or configure one or more layers, groups, display styles, object types, or other parameters in the CAD software.

The geometry submodule 340 may synthesize multiple instances of semantic content from a CAD file by modifying one or more aspects of the CAD file's content. For example, the geometry submodule 340 may change a part's geometry, add or delete geometry, add or remove annotations, add or remove parts, change view parameters or viewpoints, add or remove views, etc. In some embodiments, the geometry submodule 340 may synthesize files programmatically, and may be configured to produce semantic content consistent with parts or mechanical drawings from a particular industry, system, discipline, manufacturer, era, or other equivalence class.

A transform submodule 342 may apply one or more transforms to a generated image in applying a style. These may include a parametric or parameterized transform, which may comprise an anisotropic transform, radial distortion, spherical distortion, convolution, or the like.

The models synthesized by the image synthesis module 320 may be used as 3D models for training or testing systems for processing or analyzing 3D models or 3D geometry. The use or application of CAD models as discussed herein are non-limiting, and the methods described herein may be applicable outside CAD or mechanical engineering.

The imagery synthesis module 320 may in some embodiments produce organic or quasi-organic 2D or 3D models, such as models of geography, geographic features, plants or animals, or other natural shapes or structures. Semantic content may be sourced from or generated by or with the assistance of 2D or 3D modelling software, such as software used for 3D animation. The semantic content of some embodiments may comprise real or simulated 2D or 3D imaging from medical applications, such as magnetic resonance imaging (MRI) or computed tomography (CT), or derivatives of such imaging such as 3D reconstructions from tomographic processes. Modifications of semantic content (inputs or in by styles) may be according to models or simulations of morphology or growth processes, physical or physics models or simulations, finite element analysis, modelling or simulation, other algorithmic or stochastic functions, or generative models, according to some embodiments.

The dividing line or distinction between semantic content and results of a style is non-limiting with respect to the present disclosure. However, some annotation content of mechanical drawings may comprise semantic content or the results of a style or both. For example, the center of a circle or arc has semantic meaning and may further be rendered according to a style as a symbol denoting the center itself. Aspects of morphology associated with the synthesis or morphology of semantic content may be embodied at least in part in styles.

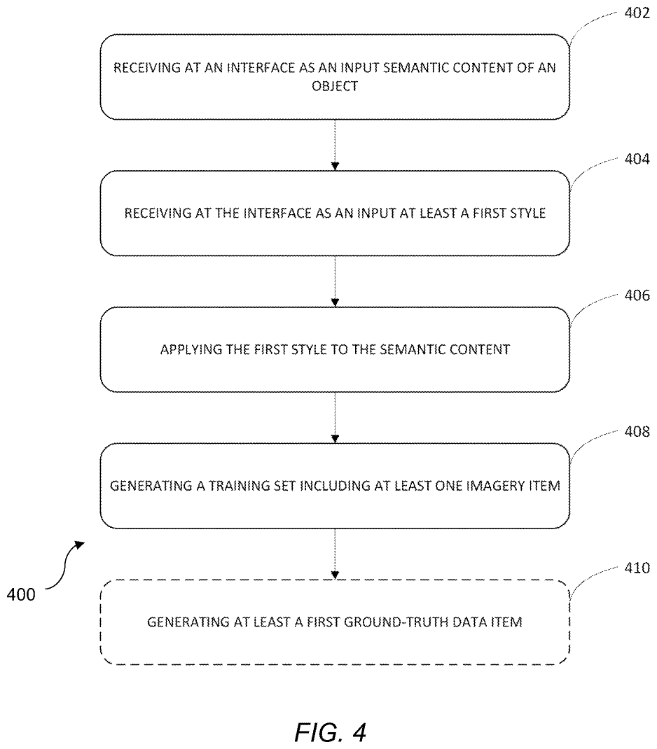

FIG. 4 depicts a flowchart of a method 400 for synthesizing training imagery in accordance with one embodiment. The system 300 of FIG. 3 or components thereof may perform the steps of method 300.

Step 402 involves receiving at an interface as an input semantic content of an object. As discussed previously, the semantic content may refer to a visual rendering or representation of a set of information regarding an object.

Step 404 involves receiving at the interface as an input at least a first style. As discussed previously, the style may refer to an imagery item's syntax or visual form, which may be a function of artistic and/or aesthetic characteristics.

Step 406 involves applying, using one or more processors executing instructions stored on memory, the first style to the semantic content. For example, the image synthesis module 320 of FIG. 3 may generate one or more models or otherwise imagery of the semantic content with the style applied thereto.

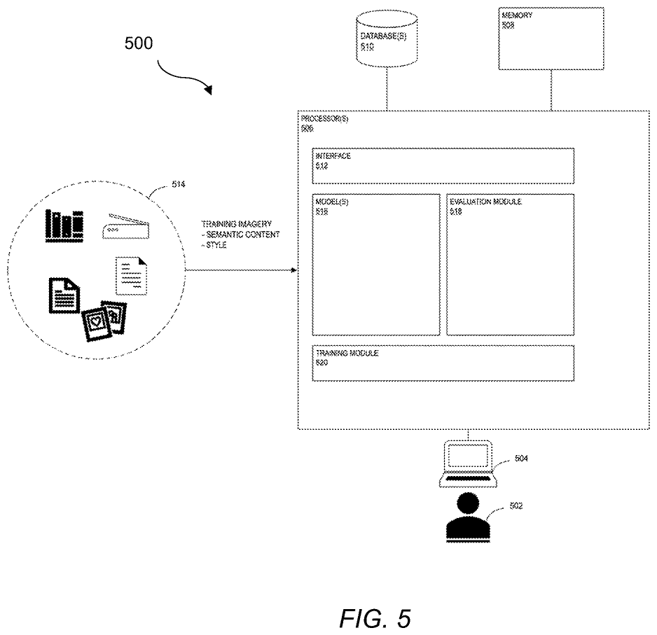

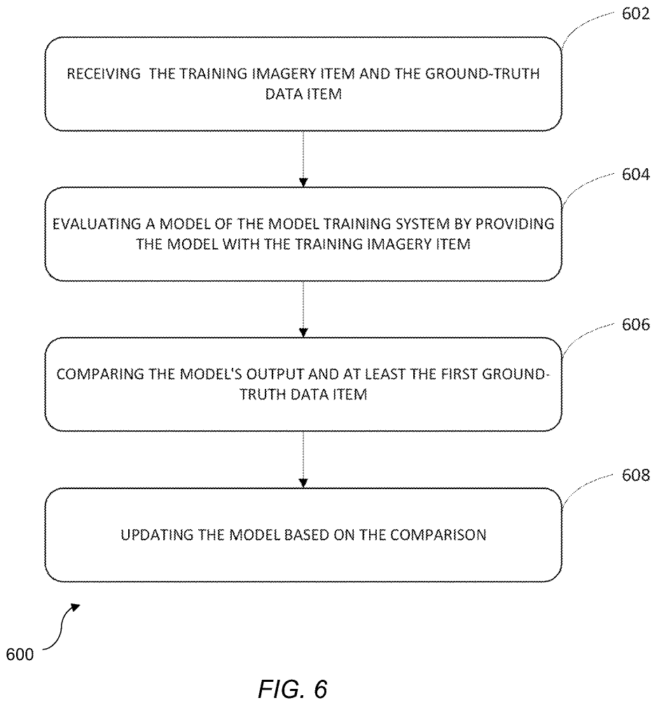

Step 408 involves generating, using the one or more processors, a training set including at least one training imagery item comprising a rendering of the first style applied to the semantic content of the object. Step 410 involves generating, using the one or more processors, at least a first ground-truth data item comprising the first style applied to the semantic content. The ground-truth data item may be used to evaluate the outputs of various models of training imagery items, discussed below in conjunction with FIGS. 5 and 6.

FIG. 5 illustrates a model training system 500 in accordance with one embodiment. Although shown as a separate system 500, the components thereof may be implemented with or in conjunction with the system 300 of FIG. 3 and method 400 of FIG. 4.

The system 500 may be similar to the system 300 of FIG. 3 and may include similar components. A user 502 may access a user device 504 for performing operations related to the described embodiments. The user device 504 may execute or otherwise be in operable communication with one or more processors 506 executing instructions stored in memory 508 and in communication with a database 510. The processors 506, memory 508, and database 510 may be configured similarly to the processors 306, memory 308, and database 310, respectively, of FIG. 3. The interface 512 may be configured similarly to the interface 312 of FIG. 3, and receive training content 514, which may include imagery, semantic content, style data, as well as other types of metadata.

The processors 506 may include or otherwise execute at least one model 516, an evaluation module 518, and a training module 520. The model(s) 516 may each receive the training imagery from the one or more sources 514. This received training imagery may include the imagery, semantic content, and possibly the style(s) discussed in conjunction with FIG. 3.

The evaluation module 518 may receive the training imagery, along with the semantic content and possibly the style information as external inputs. The evaluation module 518 may assess the accuracy of the output of the model 516 and, namely, how the extracted semantic content compares with a ground-truth outputted by the system 300 of FIG. 3. The training module 520 may provide any updates or modifications to the model 516 based on the comparison.

FIG. 6 depicts a flowchart of a method 600 for synthesizing imagery in accordance with one embodiment. The steps of method 600 may be performed in conjunction with the steps of method 400 of FIG. 4, for example.

Step 602 involves receiving at a model training system at least the training imagery item and at least the first ground-truth data item. The ground-truth data item may be stored in the database(s) such as the database 510 of FIG. 5, and may comprise an output of the system 300 of FIG. 3. Step 604 involves evaluating, using one or more processors, a model of the model training system by providing the model with the training imagery item. The model may, for example, extract the semantic content associated with the training imagery, and provide an output based on the imagery, semantic content, and possibly style(s).

Step 606 involves comparing, using one or more processors, the model's output and at least the first ground-truth data item. An evaluator such as the evaluation module 518 may receive the training imagery, together with the semantic content and style information as external inputs, and compare the same with the output from the model 516. Step 608 involves updating the model based on the comparison.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method for synthesizing training imagery, the method comprising:
receiving at an interface as an input semantic content of an object;
receiving at the interface as an input at least a first style;
applying, using one or more processors executing instructions stored on memory, the first style to the semantic content; and
generating, using the one or more processors, a training set including at least one training imagery item comprising a rendering of the first style applied to the semantic content of the object.

2. The method of claim 1 wherein the at least one training imagery item includes a visual representation or a rendering of the object.

3. The method of claim 1 wherein the semantic content includes structured data, numeric data, metadata, parameterization, metadata, or a representation or encoding of a geometric or visual element.

4. The method of claim 1 further comprising generating, using the one or more processors, at least a first ground-truth data item comprising the first style applied to the semantic content.

5. The method of claim 4 further comprising:
receiving at a model training system at least the training imagery item and at least the first ground-truth data item;
evaluating, using the one or more processors, a model of the model training system by providing the model with the training imagery item;
comparing, using one or more processors, the model's output and at least the first ground-truth data item; and
updating the model based on the comparison.

6. The method of claim 1 wherein at least one of the application of the first style to the semantic content or a rendering of the first style applied to the semantic content is deterministic.

7. The method of claim 1 wherein the training imagery item is a synthetic imagery item of the object.

8. The method of claim 1 wherein the generated training set includes a plurality of training imagery items, wherein each of the plurality of training imagery items includes the semantic content with a different style applied.

9. The method of claim 1 wherein applying the first style to the semantic content includes applying at least one of a parametric transform or a noise parameter to the semantic content.

10. The method of claim 1 wherein the semantic content includes machine-readable instructions.

11. A system for synthesizing training imagery, the system comprising:
an interface for receiving:
semantic content of an object, and
at least a first style; and
one or more processors executing instructions stored on memory and configured to:
apply the first style to the semantic content, and
generate a training set including at least one training imagery item comprising a rendering of the first style applied to the semantic content of the object.

12. The system of claim 11 wherein the at least one training imagery item includes a visual representation or a rendering of the object.

13. The system of claim 11 wherein the semantic content includes structured data, numeric data, metadata, parameterization, metadata, or a representation or encoding of a geometric or visual element.

14. The system of claim 11 wherein the one or more processors are further configured to generate at least a first ground-truth data item comprising the first style applied to the semantic content.

15. The system of claim 11 wherein the one or more processors are further configured to execute a model training system configured to:
receive at least the training imagery item and at least the first ground-truth data item,
evaluate a model of the model training system by providing the model with the training imagery item,
compare the model's output and at least the first ground-truth data item, and
update the model based on the comparison.

16. The system of claim 11 wherein at least one of the application of the first style to the semantic content or a rendering of the first style applied to the semantic content is deterministic.

17. The system of claim 11 wherein the training imagery item is a synthetic imagery item of the object.

18. The system of claim 11 wherein the generated training set includes a plurality of training imagery items, wherein each of the plurality of training imagery items includes the semantic content with a different style applied.

19. The system of claim 11 wherein the one or more processors apply the first style to the semantic content by applying at least one of a parametric transform or a noise parameter to the semantic content.

20. The system of claim 11 wherein the semantic content includes machine-readable instructions.
